(19) United States
(12) Patent Application Publication
(10) Pub. No.: US 2016/0025867 A1
(43) Pub. Date: Jan. 28, 2016

(54) CT DETECTOR

(71) Applicant: GE Medical Systems Global Technology Company, LLC, Waukesha, WI (US)

(72) Inventors: Yunfeng SUN, Beijing (CN); Qinglei LI, Beijing (CN); Guanying NIE, Beijing (CN); Deqi CUI, Beijing (CN)

(21) Appl. No.: 14/807,906

(22) Filed: Jul. 24, 2015

(30) Foreign Application Priority Data
Jul. 25, 2014 (CN) 201410360281.1

(51) Int. Cl. G01T 1/20; G21K 1/02; G01N 23/04

(52) U.S. Cl. CPC G01T 1/2002; G01N 23/046; G21K 1/02

(57) ABSTRACT

A CT detector, comprising: a detector module that includes multiple scintillators having gaps there between and for constituting two-dimensional discrete pixels; a collimator plate located above one side of the detector module receiving X-rays, for guiding the X-rays to the corresponding two-dimensional discrete pixels; and further comprising grids located between the detector module and the collimator plate, for blocking the X-rays emitted to the gaps.

### CROSS-REFERENCE TO RELATED APPLICATIONS

This application claims foreign priority benefits under 35 U.S.C. §119(a)-(d) to Chinese Application No. CN 201410360281.1, filed Jul. 25, 2014, which is hereby incorporated by reference in its entirety.

### FIELD OF THE INVENTION

Embodiments of the present invention relate to the technical field of a detector, and more particularly to a CT detector.

### BACKGROUND

As shown in FIG. 1, in a computerized tomography (CT) apparatus, a detector 103 can be used for receiving X-rays emitted by a X-ray tube 101 (a bulb tube) and penetrating through a to-be-detected object 102 and for converting the X-rays to electric signals. Usually, the detector 103 may include multiple detector modules 1031, 1032 and the like.

A CT detector in the prior art includes more detector modules, each of which has fewer channels (i.e., pixels) in the X direction (i.e., a direction of an arc in which the detector rotates). In this way, these detector modules can be set in the shape of the arc or approximately in the shape of the arc, so as to have equal pixel dimensions. Moreover, with respect to the focus of the bulb tube, equal pixel dimensions have equal flare angles.

For cost reduction, the number of detector modules included in another CT detector in the prior art is less than that of the arc detectors as described above, and the number of channels within each detector module is significantly more than that of channels of each detector module in the arc detectors. In other words, each detector module has a wider surface. Therefore, multiple such detector modules are shaped to be a polyline in which multiple straight segments connect with each other in the X direction. In such a detector, with respect to the focus of the bulb tube, the pixels with equal dimensions do not correspond to equal flare angles.

As shown in FIG. 2, no matter which type as described above a CT detector is, scintillators (blocks in FIG. 2) for constituting pixels in the detector modules thereof may be arranged in the X direction and in the Z direction, in which the adjacent scintillators have gaps there between that are often filled with a material for connecting the adjacent pixels. After X-rays are often emitted into the gaps, the performance of the material will be affected. Furthermore, with respect to the CT detector in which the straight segments connect with each other as described above, different widths can be generated on the surface of the detector due to equal flare angles of irradiation, the result may be that the X-rays are shifted to the adjacent pixels, crosstalk is produced, causing the finally generated image to have artifacts.

Therefore, there is a need to provide a CT detector, being capable of preventing the X-rays from entering the gaps between the adjacent scintillators in the detector modules and preventing the X-rays from shifting to the adjacent pixels to produce crosstalk.

### SUMMARY

One embodiment of the present invention provides a CT detector, comprising: a detector module that includes multiple scintillators having gaps therebetween and for constituting two-dimensional discrete pixels; a collimator plate located above one side of the detector module receiving X-rays, for guiding the X-rays to the corresponding two-dimensional discrete pixels; further comprising grids located between the detector module and the collimator plate, for blocking the X-rays emitted to the gaps.

### BRIEF DESCRIPTION OF THE DRAWINGS

The present invention can be understood better in light of the description of embodiments of the present invention with reference to the accompanying drawings, in which:

FIG. 1 illustrates a schematic diagram of an overall structure of a CT machine;

FIG. 2 illustrates a top view of scintillators for constituting two-dimensional discrete pixels in a detector module;

FIG. 3 illustrates a schematic diagram of an overall structure of one embodiment of a CT detector according to the present invention;

FIG. 4 illustrates a sectional view of the positions of two-dimensional grids provided in a CT detector according to an embodiment of the present invention;

FIG. 5 illustrates a top view of the positions of two-dimensional grids provided in a CT detector according to an embodiment of the present invention;

FIG. 6 illustrates a top view of one embodiment of the grid shapes in a CT detector according to an embodiment of the present invention; and

FIG. 7 illustrates a top view of another embodiment of the grid shapes in a CT detector according to an embodiment of the present invention.

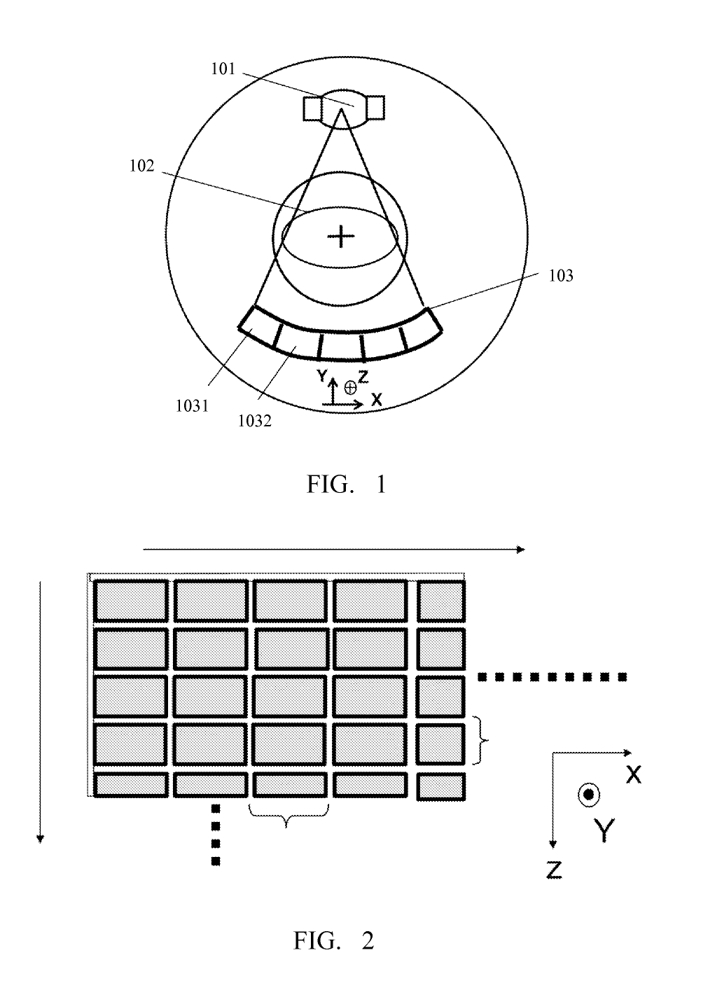

### DETAILED DESCRIPTION

Hereafter, a detailed description will be given for embodiments of the present invention. It should be pointed out that in the detailed description of the embodiments, for simplicity and conciseness, it is impossible for the Description to describe all the features of the practical embodiments in details. It should be understood that in the process of a practical implementation of any embodiment, just as in the process of an engineering project or a designing project, in order to achieve a specific goal of the developer and in order to satisfy some system-related or business-related constraints, a variety of decisions will usually be made, which will also be varied from one embodiment to another. In addition, it can also be understood that although the effort made in such developing process may be complex and time-consuming, some variations such as design, manufacture and production on the basis of the technical contents disclosed in the disclosure are just customary technical means in the art for those of ordinary skilled in the art relating to the contents disclosed in the present invention, which should not be regarded as insufficient disclosure of the present invention.

Unless defined otherwise, all the technical or scientific terms used in the Claims and the Description should have the same meanings as commonly understood by one of ordinary skilled in the art to which the present invention belongs. The terms “first”, “second” and the like in the Description and the Claims of the present application for invention do not mean any sequential order, number or importance, but are only used for distinguishing different components. The terms “a”, “an” and the like do not denote a limitation of quantity, but denote the existence of at least one. The terms “comprises”, “comprising”, “includes”, “including” and the like mean that the element or object in front of the “comprises”, “comprising”, “includes” and “including” encompasses the elements or objects and their equivalents illustrated following the “comprises”, “comprising”, “includes” and “including”, but do not exclude other elements or objects. The term “coupled”, “connected” or the like is not limited to being connected physically or mechanically, nor limited to being connected directly or indirectly.

This description with reference to the accompanying drawings is provided to assist in a comprehensive understanding of certain embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments may be made without departing from the scope and spirit of the present disclosure. In addition, descriptions of well-known functions and constructions may be omitted for clarity and conciseness.

A CT detector usually includes multiple detector modules and multiple collimator plate. FIG. 3 illustrates one detector module 301 and the corresponding collimator plate 302 in the CT detector. The detector module 301 includes multiple scintillators 303 having gaps therebetween and for constituting two-dimensional discrete pixels, a photoelectric receiving diode 304, and a module pedestal 305. The scintillators may be arranged in the X direction and in the Z direction (along a vertical direction of a human body) to constitute a two-dimensional pixel array. The photoelectric receiving diode 304 may be mounted on the module pedestal 305, and the scintillators 303 may be mounted on the photoelectric receiving diode 304. The collimator plate 302 is located above one side of the detector module 301 receiving X-rays, for guiding the X-rays to the corresponding two-dimensional discrete pixels. The upper edge of the collimator plate 302 may be focused on a focus of a bulb tube of the X-rays, and the thickness of the collimator plate 302 is in the X direction.

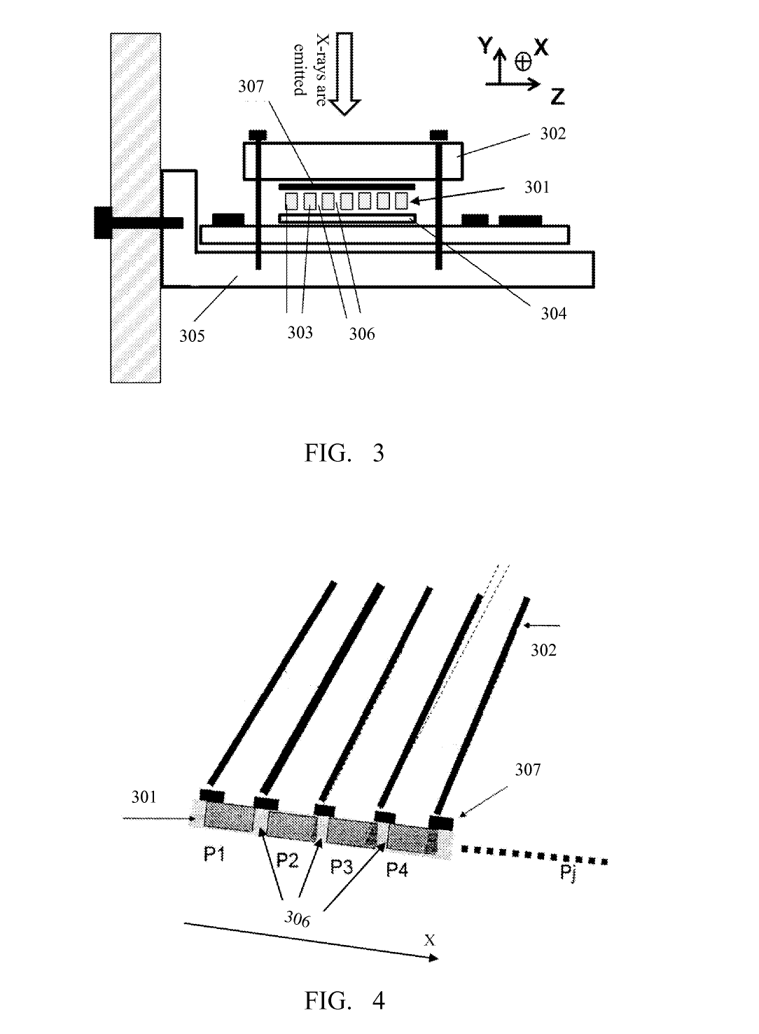

No matter for an arc detector or for a detector of a polyline-segment type, there are certain gaps 306 between the multiple scintillators 303 within the detector module 301. Therefore, in one embodiment of the present invention, as shown in FIG. 3 in conjunction with FIG. 4, grids 307 may also be provided between the detector module 301 and the collimator plate 302, used to block the X-rays emitted to the gaps 306. In one embodiment of the present invention, the grids 307 may also be mounted on or above the scintillators 303. In one embodiment of the present invention, the lower edge of the collimator plate 302 may be positioned on the grids 307 or located above the grids 307.

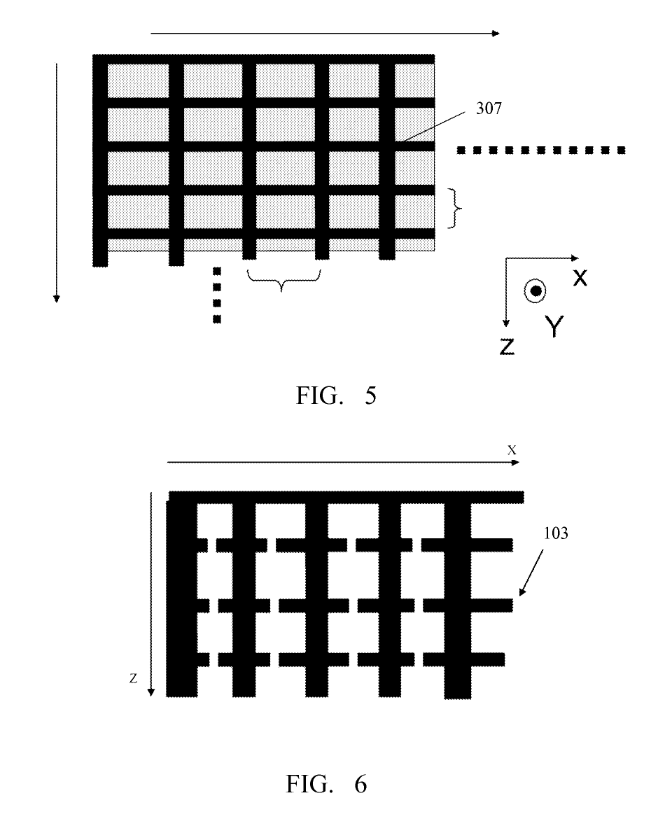

In one embodiment of the present invention, with reference to FIG. 5, the grids 307 may be provided on the gaps in two intersecting directions. In conjunction with FIG. 6, the grids 307 may be provided on the gaps in the X direction and in the Z direction, and may have a breaking joint on at least one gridline that is along the X direction. Similarly, there may also be a breaking joint on at least one gridline that is along the Z direction, or there may be breaking joints on at least one gridline that are along both the X direction and the Z direction. It should be emphasized that the positions of the breaking joints on different gridlines may be aligned, or may be not aligned. Although the breaking joints on the multiple gridlines that are along the X direction as shown in FIG. 6 are aligned in the Z direction, the positions of these breaking joints may also be not aligned in the Z direction.

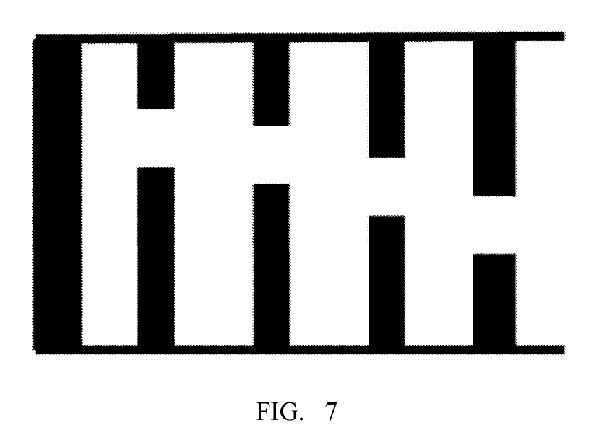

In another embodiment of the present invention, the grids 307 may be provided on the gaps in only one direction. With reference to FIG. 7, the grids 307 may be provided on the gaps only in the X direction, and may have breaking joints on at least one gridline that is along the X direction.

In one embodiment of the present invention, the grids may have a thickness between 80 micrometers and 10 millimeters.

In one embodiment of the present invention, the gridlines in the grids themselves may have a width between 10 micrometers and 700 micrometers.

In one embodiment of the present invention, two adjacent gridlines in the grids have a pitch between 0.08 millimeters and 3 millimeters.

In one embodiment of the present invention, the grids may be made of a composite material containing tungsten or a high density alloy, or for strongly absorbing the X-rays.

In one embodiment of the present invention, the gridlines may be provided on the gaps not only asymmetrically but also symmetrically. No matter whether the gridlines are symmetrically or asymmetrically provided, a criterion can both be satisfied that the gaps are ensured to be covered by the gridlines so as not to be irradiated by the X-rays. Moreover, when it is required to use the gridlines to eliminate crosstalk of the X-rays on the adjacent pixels, the gridlines may also cover areas on the adjacent pixels that may receive the crosstalk of the X-rays.

So far a CT detector according to embodiments of the present invention has been described. According to the CT detector of embodiments of the present invention, the X-rays can be prevented from entering the gaps between the adjacent pixels in the detector module, and the X-rays can be prevented from shifting to the adjacent pixels to produce crosstalk. In addition, the grids having the breaking joint are beneficial for the manufacture of the grids such that during the cutting process of the grids, a processing apparatus is capable of, after cutting out one blank, continuously moving into a next blank adjacent to the blank to process the next blank.

The embodiments of the present invention have been described in the above, and are not used to limit the present invention. For those skilled in the art, various alterations and changes may be made to the present invention. In the spirit and the principle of the present invention, any modification, equivalents, improvement etc. made thereto all should fall within the scope of the Claims of the prevent invention.

What is claimed is:

1. A CT detector, comprising:
a detector module comprising a plurality of scintillators having gaps there between and for constituting two-dimensional discrete pixels;
a collimator plate located above one side of said detector module, wherein said collimator plate is configured to receive X-rays and guide said X-rays to the corresponding two-dimensional discrete pixels; and
grids located between said detector module and said collimator plate, wherein said plurality of grids is configured to block said X-rays emitted to said gaps.

2. The CT detector according to claim 1, wherein said grids are provided on said gaps in two intersecting directions, and comprise a breaking joint in at least one of said directions.

3. The CT detector according to claim 1, wherein said grids are provided on said gaps in one direction and have a breaking joint in said direction.

4. The CT detector according to claim 2, wherein said grids have a thickness between 80 micrometers and 10 millimeters.

5. The CT detector according to claim 2, wherein gridlines in said grids have a width between 10 micrometers and 700 micrometers.

6. The CT detector according to claim 2, wherein two adjacent gridlines in said grids have a pitch between 0.08 millimeters and 3 millimeters.

7. The CT detector according to claim 2, wherein said grids are made of a composite material containing a high density alloy.

8. The CT detector according to claim 2, wherein said grids are made of a composite material containing tungsten.

9. The CT detector according to claim 2, wherein said grids are made of a composite material configured to absorb said X-rays.

10. The CT detector according to claim 2, wherein said grids are asymmetrically provided on said gaps.

11. The CT detector according to claim 2, wherein said grids are symmetrically provided on said gaps.

12. The CT detector according to claim 1, further comprising a plurality of detector modules configured to be polyline-shaped.

13. The CT detector according to claim 2, further comprising a plurality of detector modules configured to be polyline-shaped.

14. The CT detector according to claim 3, further comprising a plurality of detector modules configured to be polyline-shaped.

15. The CT detector according to claim 4, further comprising a plurality of detector modules configured to be polyline-shaped.

16. The CT detector according to claim 5, further comprising a plurality of detector modules configured to be polyline-shaped.

17. The CT detector according to claim 6, further comprising a plurality of detector modules configured to be polyline-shaped.

18. The CT detector according to claim 7, further comprising a plurality of detector modules configured to be polyline-shaped.

19. The CT detector according to claim 8, further comprising a plurality of detector modules configured to be polyline-shaped.

20. The CT detector according to claim 9, further comprising a plurality of detector modules configured to be polyline-shaped.
